(19) United States
(12) Patent Application Publication
(10) Pub. No.: US 2025/0310782 A1
(43) Pub. Date: Oct. 2, 2025

(54) DEPLOYMENT OF ACCELERATION ABSTRACTION LAYER IN CELLULAR COMMUNICATION SYSTEMS

(71) Applicant: Nokia Technologies Oy, Espoo (FI)

(72) Inventors: Michael JARSCHEL, Munich (DE); Mu HE, Munich (DE); Hasanin HARKOUS, Munich (DE); Padmavathi SUDARSAN, Naperville, IL (US); Jan Erik IGNATIUS, Espoo (FI); Lasse Juha Tapio TALLGREN, Espoo (FI)

(21) Appl. No.: 18/849,674

(22) PCT Filed: Mar. 30, 2022
(86) PCT No.: PCT/EP2022/058407

§ 371 Date: Sep. 23, 2024

(51) Int. Cl. H04W 16/18; H04L 41/08; H04L 41/0895

(52) U.S. Cl. CPC H04W 16/18; H04L 41/0886; H04L 41/0895

(57) ABSTRACT

According to an example aspect of the present invention, there is provided an apparatus comprising at least one processing core, at least one memory including computer program code, the at least one memory and the computer program code being configured to, with the at least one processing core, cause the apparatus at least to receive an accelerator programming request from an Acceleration Abstraction Layer, AAL,-Deployment Management Service, DMS, network component, transmit a code retrieval request to a repository network component and receive a code fragment in response, transmit a programming request with said code fragment to a hardware accelerator manager, to request the hardware accelerator manager to program at least one hardware accelerator node, receive an indication indicating that the programming was successful in response to transmitting the programming request and transmit an indication indicating that accelerator programming was successful to the AAL-DMS.

### FIELD

Various example embodiments relate in general to cellular communication systems and more specifically, to deployment of acceleration abstraction layer in such systems.

### BACKGROUND

Acceleration Abstraction Layer, AAL, may be used to abstract, i.e., differentiate, implementation specifics of special purpose hardware acceleration devices and to expose a standardized Application Programming Interface, API, in various cellular communication systems, such as in 5G systems. However, at least for 5G systems there is a need to provide a dynamic and flexible AAL deployment mechanism which works during a run-time of an open cloud node. Such improvements may be useful in other cellular communication systems as well in the future.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to an aspect of the present invention, there is provided an apparatus comprising at least one processing core, at least one memory including computer program code, the at least one memory and the computer program code being configured to, with the at least one processing core, cause the apparatus at least to receive an accelerator programming request from an Acceleration Abstraction Layer, AAL,-Deployment Management Service, DMS, network component, transmit a code retrieval request to a repository network component and receive a code fragment in response, transmit a programming request with said code fragment to a hardware accelerator manager, to request the hardware accelerator manager to program at least one hardware accelerator node, receive an indication indicating that the programming was successful in response to transmitting the programming request and transmit an indication indicating that accelerator programming was successful to the AAL-DMS.

The at least one memory and the computer program code may be further configured to, with the at least one processing core, cause the apparatus at least to operate as an Accelerator Programming, AP,-DMS network component.

According to an aspect of the present invention, there is provided an apparatus comprising at least one processing core, at least one memory including computer program code, the at least one memory and the computer program code being configured to, with the at least one processing core, cause the apparatus at least to transmit an accelerator programming request to an Accelerator Programming, AP,-Deployment Management Service, DMS, network component, receive an indication indicating that accelerator programming was successful from the AP-DMS and transmit a program completion message to a deploy DMS.

The at least one memory and the computer program code may be configured to, with the at least one processing core, cause the apparatus at least to operate as an Acceleration Abstraction Layer, AAL,-DMS network component.

The at least one memory and the computer program code may be configured to, with the at least one processing core, cause the apparatus at least to receive, from a deploy DMS, a request to program an accelerator and transmit the accelerator programming request responsive to receiving the request.

The accelerator programming request may be a request to program at least one hardware accelerator node.

The accelerator programming request may be a request to program at least one hardware accelerator node for another network component. Said another network component may be an application or a cloudified network function.

According to an aspect of the present invention, there is provided a system, comprising a system, comprising an Acceleration Abstraction Layer, AAL,-Deployment Management Service, DMS, network component and an Accelerator Programming, AP-DMS network component, wherein the AP-DMS network component is configured to receive an accelerator programming request from the AAL-DMS network component, transmit a code retrieval request to a repository network component and receive a code fragment in response, transmit a programming request with said code fragment to a hardware accelerator manager, to request the hardware accelerator manager to program at least one hardware accelerator node, receive an indication indicating that the programming was successful in response to transmitting the programming request and transmit an indication indicating that accelerator programming was successful to the AAL-DMS; and the AAL-DMS network component is configured to transmit an accelerator programming request to an AP-DMS network component, receive an indication indicating that accelerator programming was successful from the AP-DMS and transmit a program completion message to a deploy DMS.

The AAL-DMS network component may be configured to receive, from a deploy DMS, a request to program an accelerator and transmit the an accelerator programming request responsive to receiving the request.

The accelerator programming request may be a request to program at least one hardware accelerator node.

The accelerator programming request may be a request to program at least one hardware accelerator node for another network component.

Said another network component may be an application or a cloudified network function.

According to an aspect of the present invention, there is provided a first method, comprising receiving an accelerator programming request from an Acceleration Abstraction Layer, AAL,-Deployment Management Service, DMS, network component, transmitting a code retrieval request to a repository network component and receiving a code fragment in response, transmitting a programming request with said code fragment to a hardware accelerator manager, to request the hardware accelerator manager to program at least one hardware accelerator node, receiving an indication indicating that the programming was successful in response to transmitting the programming request and transmitting an indication indicating that accelerator programming was successful to the AAL-DMS.

According to an aspect of the present invention, there is provided a second method, comprising transmitting an accelerator programming request to an Accelerator Programming, AP,-Deployment Management Service, DMS, network component, receiving an indication indicating that accelerator programming was successful from the AP-DMS and transmitting a program completion message to a deploy DMS.

According to an aspect of the present invention, there is provided an apparatus, comprising means for performing the first method. According to an aspect of the present invention, there is provided an apparatus, comprising means for performing the second method.

According to an aspect of the present invention, there is provided a non-transitory computer readable medium having stored thereon a set of computer readable instructions that, when executed by at least one processor, cause an apparatus to at least perform the first or the second method. According to an aspect of the present invention, there is provided a computer program comprising instructions which, when the program is executed by an apparatus, cause the apparatus to carry out the first or the second method.

### BRIEF DESCRIPTION OF THE DRAWINGS

FIG. 1 illustrates an architecture in accordance with at least some example embodiments;

FIG. 2 illustrates a first signalling graph in accordance with at least some example embodiments;

FIG. 3 illustrates a second signalling graph in accordance with at least some example embodiments;

FIG. 4 illustrates an example apparatus capable of supporting at least some example embodiments;

FIG. 5 illustrates a flow graph of a method in accordance with at least some example embodiments; and

### EXAMPLE EMBODIMENTS

Deployment of Acceleration Abstraction Layer, AAL, in cellular communication systems may be improved by the procedures described herein. More specifically, the cellular communication system may comprise a mapping Deployment Management Service, DMS, network component and a deploy DMS network component in an open cloud network of the cellular communication system. An apparatus operating as Service Management and Orchestration, SMO, network component may then request the mapping DMS network component to map another network component to at least one hardware accelerator node in the open cloud network. The apparatus may also request the deploy DMS to deploy the at least one hardware accelerator node for said another network component. Therefore, dynamic and flexible AAL deployment is enabled during a run-time of at least one hardware accelerator node. In some example embodiments, the acceleration may be used for base station packet processing.

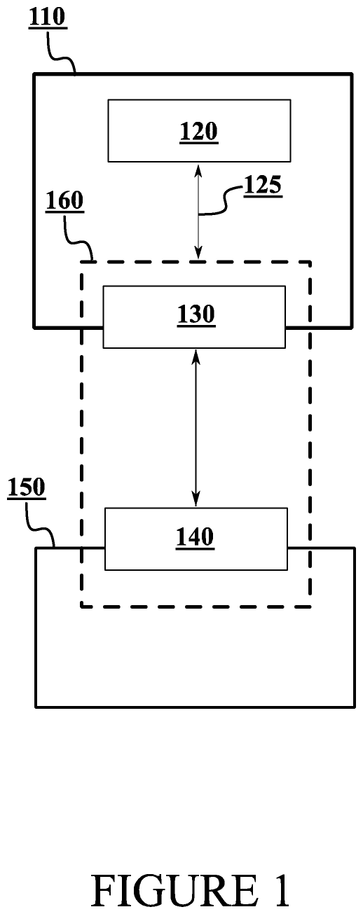

FIG. 1 illustrates an architecture in accordance with at least some example embodiments. In FIG. 1, Cloudified Network Function, CNF, is denoted by 110. CNF 110 may be associated with an Open Radio Access Network, O-RAN. CNF 110 may further comprise, or at least be associated with, application 120. Application 120 may for example process address space. Application 120 may be connected to library and/or driver 130 via AAL interface 125. Library and/or driver 130 may be further connected to Hardware, HW, accelerator 140 of Open Cloud, O-Cloud, node 150, e.g., via a vendor specific interface, which may not be specified/standardized. FIG. 1 may for example illustrate a relationship between AAL, O-Cloud and application as defined in O-RAN.WG6.AAL-GAnP-v01.05 “O-RAN Acceleration Abstraction Layer General Aspects and Principles” specification. AALI implementation is denoted by 160.

Application 120 may access HW accelerator 140 through AAL interface 125, wherein AAL interface 125 may be exposed by library and/or driver 130, such as an infrastructure software library and/or driver in user and/or kernel space of O-Cloud node 150 that application 120 resides on. AAL interface 125 may be standard compliant whereas the implementation of the abstraction layer of CNF 110 as well as its interface with HW accelerator 140 may be proprietary. In some example embodiments, it may be assumed that the AAL gets provisioned together with O-Cloud node 150 it is interacting with.

At least one challenge related to deployment of AAL is that while fixed-function HW accelerators may be provisioned with a corresponding AAL software from the start, the situation is different for programmable devices and software-based acceleration. It may be generally assumed that accelerated Radio Access Network, RAN, functions, like O-cloud node 150 in FIG. 1, may be deployed at edge or far-edge locations, wherein a small footprint of server installations may make resources scare.

At the same time, such accelerated RAN functions at these edge locations may not be meant to be dedicated hosts for RAN functions but also support a variety of new edge computing use cases, e.g., Extended Reality, XR, applications, wherein proximity to the user may be required. Therefore, it may be prudent to only deploy AAL software on a programmable node when O-Cloud node 150 itself and programmable HW accelerator 140 inside O-Cloud node 150 are actually used to host RAN functionality. Otherwise, a significant amount of the scarce edge resources may be wasted to run an Application Programming Interface, API, framework that is not used at all. There is therefore a need to introduce a dynamic and flexible AAL deployment mechanism which may be used during run-time of O-Cloud node 150.

Embodiment of the present disclosure therefore provide a solution which may be used to handle programming of non-fixed HW accelerators, like HW accelerator 140 in FIG. 1, and dynamic provisioning of a corresponding AAL during runtime. At least some of the embodiments of the present invention may be standardized, e.g., by O-RAN WG6.

In some example embodiments, an AAL-DMS is provided. The AAL-DMS may handle deployment of an AAL software framework that may further interact with a programmable accelerator, like HW accelerator 140, for a programmed functionality and expose AAL interfaces, like AAL interface 125 in FIG. 1, to applications, such as application 120. Operation of the AAL-DMS and said AAL interfaces may be standardized.

In some example embodiments, an Accelerator Programming DMS, AP-DMS, is provided. The AP-DMS may handle artifact retrieval and acceleration programming at runtime and be initialized by the SMO, or directly through the AAL-DMS. The AP-DMS may be standardized as well.

In some example embodiments, a repository function may be used to provide pre-compiled data plane artifacts. The pre-compiled data plane artifacts may be loaded onto non-fixed function accelerators, such as HW accelerator 140 in FIG. 1. For instance, a Field Programmable Gate Array, FPGA, bitstream, may be loaded, corresponding to a required functionality and device.

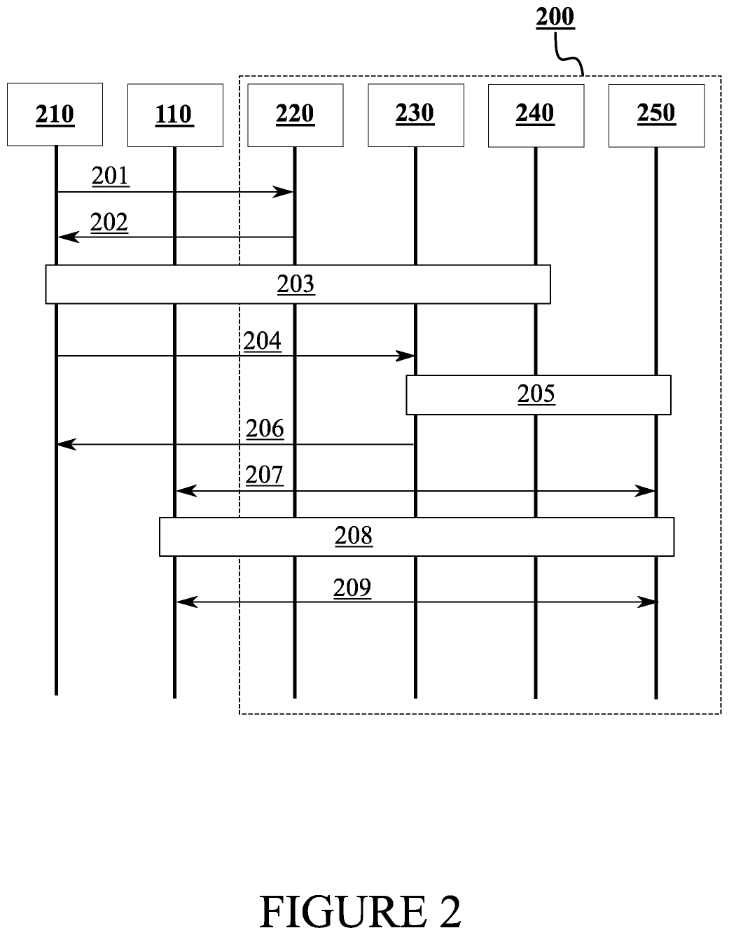

FIG. 2 illustrates a first signalling graph in accordance with at least some example embodiments. On the vertical axes are disposed, from the left to the right, SMO 210 and CNF 110 outside of O-Cloud network 200 of a cellular communication system. O-Cloud network may further comprise mapping DMS 220, deploy DMS 230, AAL-DMS 240 and AAL 250. AAL 250 may be the actual implementation of layer 160 shown in FIG. 1. Time advances from the top towards the bottom.

More specifically, FIG. 2 illustrates a high-level flow chart for a SMO-triggered O-RAN application deployment onto O-Cloud network 200 that interacts with AAL 250. SMO 210 may be a network component in a cellular communication system. In some example embodiments, deploy DMS 230 may be a Kubernetes API.

At step 201, SMO 210 may transmit a mapping request on behalf of another network component of the cellular communication system, such as CNF 110 or application 120 shown in FIG. 1, to mapping DMS network component 220 in O-Cloud network 200 of the cellular communication system, wherein the mapping request may be a mapping request to map said another network component to at least one node in O-Cloud network 200, like O-Cloud node 150 shown in FIG. 1. Mapping DMS 220 may map CNF 110 to at least one node in O-Cloud network, thereby exposing the requested AAL profiles, such as a number Logical Processing Units, LPUs, and queues, wherein different O-Cloud clusters may have different AAL profiles. Responsive to the request, SMO 210 may then receive from mapping DMS 220, at step 202, an indication, e.g., an identity, of a cluster of the at least on node in O-Cloud network 200.

The at least one node may comprise a HW accelerator. The mapping request may be for requesting that a HW of the at least one HW accelerator node is accelerated for said another network component. In some example embodiments, acceleration of the HW may refer to deploying AAL software on the at least one node. That is, AAL software may be installed on the at least one node, thereby accelerating its capabilities. The at least one HW accelerator node may be a programmable accelerator node.

The mapping request may be transmitted during a runtime of the at least one HW accelerator node. That is, the mapping request may be transmitted while the at least one HW accelerator node is running but not before that, i.e., not before starting the operation. The mapping request may be transmitted for example over an AAL interface, such as at least partly over AAL interface 125, in a core network of the cellular communication system.

In other words, SMO 210 may transmit the mapping request of CNF 110 or application 120 to mapping DMS 220 and mapping DMS 220 may provide SMO 210 with a suitable O-Cloud cluster depending on parameters specified in the mapping request, such as location, network and resource requirements of said another network component, like CNF 110 and/or application 120. Mapping DMS 220 may maintain profiles of all available cloud nodes, like O-Cloud node 150 in FIG. 1, and based on the parameters of the mapping request, map/select a certain O-Cloud cluster for said another network component. The mapped/selected O-Cloud cluster, and the node therein, should have enough resources, such as the number of LPUs and queues, to comply with the mapping request. As a response, mapping DMS 220 may transmit an indication of the selected O-Cloud cluster back to SMO 210.

At step 203, SMO 210 may transmit an AAL deployment request to AAL-DMS 240. AAL-DMS 240 may then deploy AAL functions on selected nodes and further respond by transmitting a deployment response to SMO 210. The selected nodes may be indicated in the AAL deployment request for example.

Hence, there may be interaction between SMO 210 and AAL-DMS 240 at step 203. SMO 210 may request AAL-DMS 240 to deploy the required AAL functions on O-Cloud cluster/nodes selected by mapping DMS 220. Step 203 may be necessary only if the AAL software has not been deployed before, e.g., in the case of a non-fixed-function accelerator. After receiving the AAL deployment request, AAL-DMS 240 may deploy the required AAL functions on selected nodes, like AAL 250, and return a status of the deployment back to SMO 210. Said deploying of the required AAL functions may refer, e.g., to starting software processes and/or libraries of the required AAL function.

Once the AAL is up and running on the selected node(s), such as AAL 250, the deployment of said another network component may be triggered through deploy DMS 230. SMO 210 may transmit, at step 204, a deploy request to deploy the at least one hardware accelerator node for said another network component (e.g., deploy AAL 250 for CNF 110).

At step 205, Deploy DMS 230 may deploy said another network component upon receiving the deploy request. Said deploying, at step 205, may comprise programming AAL 250 according to the requirements of CNF 110. For instance, deploy DMS 230 may program AAL-DMS 240 with required LPU functionality on accelerator. AAL-DMS 240 may further retrieve device-specific LPU image from AAL 250, program accelerator and expose LPUs. After that, AAL-DMS 240 may transmit a program completion response to deploy DMS 230. At step 206, deploy DMS 230 may transmit a deployment response to SMO 210.

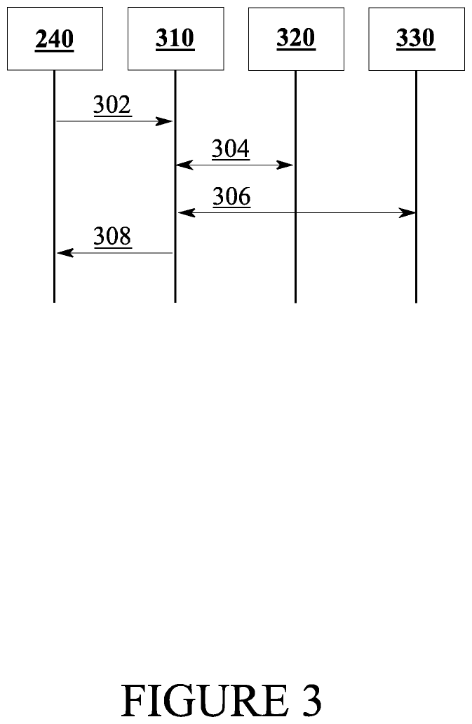

In some example embodiments, said another network component to be deployed may require HW acceleration and the selected node on which said another network component is supposed to be deployed on, may comprise a non-fixed function accelerator. In such a case, the HW accelerator may be programmed and configured properly to AALI implementation 160 so that said another network component, like CNF 110, would be able to offload tasks later. That is, HW accelerator 140 may be first programmed to have basic acceleration capability and then AALI implementation 160 may be configured on, or with, HW accelerator 140 to deploying CNF 110 later via AAL interface 125. Said programming and configuring may be handled through an AP-DMS, as explained in more detail in connection with FIG. 3.

After the successful completion of the accelerator programming, AAL 250 may be considered as fully deployed on the selected node, like O-Cloud node 150 in FIG. 1, and AAL 250 may be initialized for usage. At step 207, CNF 110 may transmit an initialization request to AAL 250 and AAL 250 may respond by transmitting an initialization response back to CNF 110. Step 207 may be needed for example as a bootstrapping step to enable communication between CNF 110 and AAL 250.

At least two different initialization alternatives may be performed at step 208. For instance, if an assumption of a fixed-function accelerator is made and no previous interaction with the accelerator or its Hardware Accelerator Manager, HAM, e.g., for programming has taken place, CNF 110 may transmit a request to get available devices to AAL 250 and receive a list of available AAL devices in response. CNF 110 may then transmit a request to get AAL device capabilities (AAL profiles) and receive AAL device capabilities in response. After that, CNF 110 may transmit a request to setup and allocated AAL device queues to AAL 250 and receive a setup response.

Alternatively, if a non-fixed function accelerator has been programmed by the AP-DMS and, the non-fixed HW accelerator node is therefore known, the message sequence may be shortened. In such a case, CNF 110 may transmit to AAL 250 a request to get available AAL devices and respective capabilities (AAL profiles) and receive in response a list of available AAL devices with capabilities from AAL 250. CNF 110 may then transmit a request to setup and allocated AAL device queues to AAL 250 and receive a setup response.

At step 209, CNF 110 may configure AAL 250 with AAL device queues and receive a configuration response from AAL 250. Upon configuring the AAL device queues properly, the initialization procedure may be considered as complete and the operation of CNF 110 may start with the at least one accelerated HW node. With reference to FIG. 1, when CNF 110 has an acceleration task to do, it may send this task to configured HW accelerator 140, e.g., via AAL interface 125.

FIG. 3 illustrates a second signalling graph in accordance with at least some example embodiments. On the vertical axes are disposed, from the left to the right, AAL-DMS 240, AP-DMS 310, repository 320 and HAM 330. Time advances from the top towards the bottom.

FIG. 3 illustrates signalling for a case, wherein the accelerator, such as HW accelerator 140 of FIG. 1, needs to be programmed and configured properly to AAL 250 so that said another component, like CNF 110, would be able to offload tasks later. At step 302, AAL-DMS may transmit an accelerator programming request to AP-DMS 310. Upon receiving the accelerator programming request, AP-DMS 310 may transmit a code retrieval request to repository 320 and receive a code fragment in response. That is, AP-DMS 310 may retrieve the required artifact to be deployed in the accelerator from repository 320, i.e., the repository function.

At step 306, AP-DMS 310 may then transmit a programming request with said code fragment to HAM 330, to request HAM 330 to program the accelerator. Upon receiving the programming request, HAM 330 may program the accelerator and inform AP-DMS 310 once programming has been successful. AP-DMS 310 may thus receive an indication indicating that the programming was successful in response to transmitting the programming request and transmit an indication indicating that accelerator programming was successful to AAL-DMS 240. That is, AP-DMS 310 may interact with HAM 330 of the accelerator device and push the code artifact, i.e. code fragment, like a piece of code, to that device and program it. In some example embodiments, HAM 330 may be a proprietary function and in such a case the programming itself would not be standardized.

At step 308, AP-DMS 310 may inform AAL-DMS 240 that the programming of the accelerator has been successful. AAL-DMS 240 may confirm the success of programming an accelerator device after that.

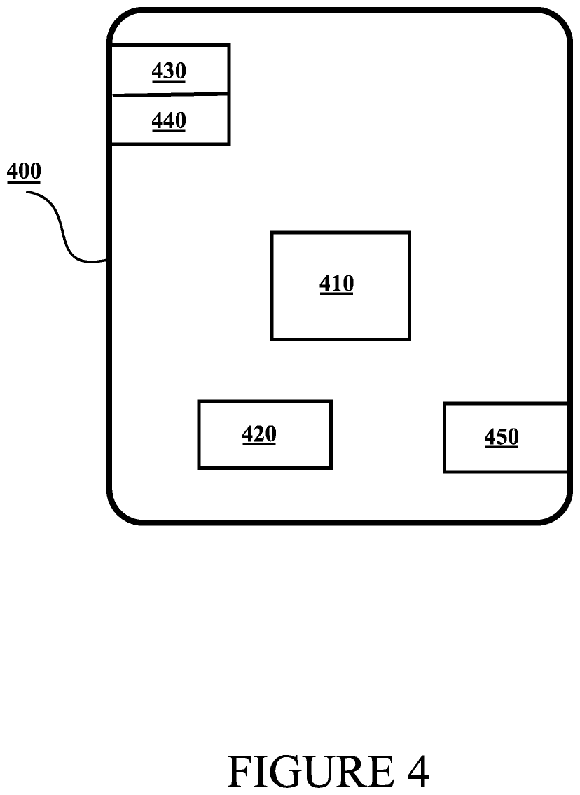

FIG. 4 illustrates an example apparatus capable of supporting at least some example embodiments. Illustrated is device 400, which may comprise, for example, a network component, like SMO 210, AAL-DMS 240 or AP-DMS 310, or a device controlling functioning thereof. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. Processor 410 may comprise at least one Application-Specific Integrated Circuit, ASIC. Processor 410 may comprise at least one Field-Programmable Gate Array, FPGA. Processor 410 may comprise an Intel Xeon processor for example. Processor 410 may be means for performing method steps in device 400, such as determining, causing transmitting and causing receiving. Processor 410 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a network function, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular standard Transmitter 430 may comprise more than one transmitter. Receiver 440 may comprise more than one receiver. Transmitter 430 and/or receiver 440 may be configured to operate in accordance with a suitable communication standard.

Device 400 may comprise User Interface, UI, 450. UI 450 may comprise at least one of a display, a keyboard, a touchscreen, a vibrator arranged to signal to a user by causing device 400 to vibrate, a speaker or a microphone. A user may be able to operate device 400 via UI 450, for example to configure device 400 and/or functions it runs.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. In some example embodiments, device 400 lacks at least one device described above. For example, device 400 may not have UI 450.

Processor 410, memory 420, transmitter 430, receiver 440 and/or UI 450 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the example embodiment various ways of interconnecting at least two of the aforementioned devices may be selected without departing from the scope of the present invention.

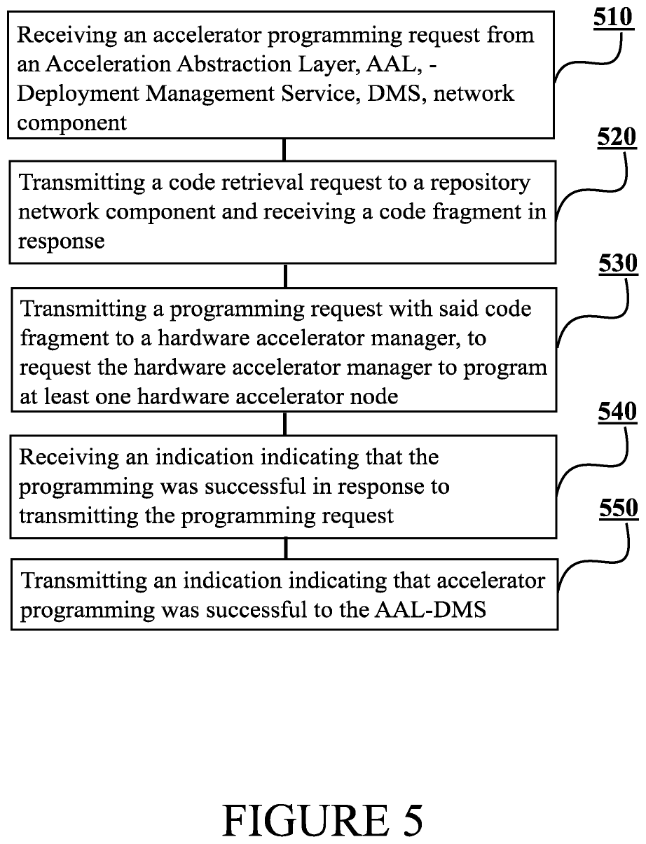

FIG. 5 is a flow graph of a first method in accordance with at least some example embodiments. The phases of the illustrated first method may be performed by an apparatus comprising a network component, like AP-DMS 310 shown in FIG. 3.

The first method may comprise, at step 510, receiving an accelerator programming request from an Acceleration Abstraction Layer, AAL,-Deployment Management Service, DMS, network component. The first method may also comprise, at step 520, transmitting a code retrieval request to a repository network component and receive a code fragment in response. Moreover, the first method may comprise, at step 530, transmitting a programming request with said code fragment to a hardware accelerator manager, to request the hardware accelerator manager to program at least one hardware accelerator node. The first method may comprise, at step 540, receiving an indication indicating that the programming was successful in response to transmitting the programming request. Finally, the first method may comprise, at step 550, transmitting an indication indicating that accelerator programming was successful to the AAL-DMS. The first method may further comprise operating an apparatus as AP-DMS 310 and the steps may be performed by the apparatus in such a case.

A second method may comprise transmitting an accelerator programming request to an Accelerator Programming, AP,-Deployment Management Service, DMS, network component, receiving an indication indicating that accelerator programming was successful from the AP-DMS and transmitting a program completion message to a deploy DMS. The second method may be performed by an apparatus comprising a network component, like AAL-DMS 240 shown in FIGS. 2 and 3. The second method may further comprise operating an apparatus as AAL-DMS 240 and the steps may be performed by the apparatus in such a case.

In some example embodiments, a third method may comprise operating an apparatus as a Service Management and Orchestration, SMO, network component in a cellular communication system, transmitting, by the apparatus, a request on behalf of another network component of the cellular communication system to a mapping Deployment Management Service, DMS, network component in an open cloud network of the cellular communication system, wherein the request is a mapping request to map said another network component to at least one hardware accelerator node in the open cloud network, receiving, by the apparatus, from the mapping DMS network component, an indication of a cluster of the at least one hardware accelerator node in the open cloud network responsive to the mapping request, transmitting to a deploy DMS network component in the open cloud network of the cellular communication system, by the apparatus, a deploy request to deploy the at least one hardware accelerator node for said another network component and receiving, by the apparatus, a deployment response from the deploy DMS.

Said another network component may be an application or a cloudified network function.

The third method may comprise transmitting, by the apparatus, an Acceleration Abstraction Layer, AAL, deployment request to an AAL-DMS network component and receiving from the AAL-DMS network component, by the apparatus, a deployment response.

The at least one hardware accelerator node may comprise a hardware accelerator.

The mapping request may comprise a location, network and/or resource requirement of said another network component.

The mapping request may be for requesting that a hardware of the at least one hardware accelerator node is accelerated for said another network component.

The mapping request may be transmitted during a runtime of the at least one hardware accelerator node.

The at least one hardware accelerator node may be a programmable accelerator node.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, comprising for example a network component, like SMO 210, may further comprise means for carrying out the example embodiments described above and any combination thereof.

In an example embodiment, a computer program may be configured to cause a method in accordance with the example embodiments described above and any combination thereof. In an exemplary example embodiment, a computer program product, embodied on a non-transitory computer readable medium, may be configured to control a processor to perform a process comprising the example embodiments described above and any combination thereof.

In an example embodiment, an apparatus, comprising for example a network component, like SMO 210, may further comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the example embodiments in one or more particular applications, it will be apparent to those of ordinary skill in the art that numerous modifications in form, usage and details of implementation may be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

The expression “at least one of A or B” in this document means A, or B, or both A and B.

### INDUSTRIAL APPLICABILITY

At least some example embodiments find industrial application in cellular communication systems, such as 5G systems, and possibly in other cellular communication systems in the future wherein it is desirable to use a dynamic and flexible AAL deployment mechanism.

### ACRONYMS LIST

AAL Acceleration Abstraction Layer
AP Accelerator Programming
API Application Programming Interface
ASIC Application-Specific Integrated Circuit
CNF Cloudified Network Function
DMS Deployment Management Service
FPGA Field Programmable Gate Array
HAM Hardware Accelerator Manager
HW Hardware
LPU Logical Processing Unit
O-RAN Open Radio Access Network
O-Cloud Open Cloud
RAN Radio Access Networks
SMO Service Management and Orchestration
UI User Interface
XR Extended Reality

REFERENCE SIGNS LIST

| | |
|---|---|
| 110 | CNF |
| 120 | Application |
| 125 | AAL interface |
| 130 | Library/driver |
| 140 | HW accelerator |
| 150 | O-Cloud node |
| 160 | AALI implementation |
| 200 | O-Cloud network |
| 201-209 | Steps in FIG. 2 |
| 210 | SMO |
| 220 | Mapping DMS |
| 230 | Deploy DMS |
| 240 | AAL-DMS |
| 250 | AAL |
| 302-308 | Steps in FIG. 3 |
| 310 | AP-DMS |
| 320 | Repository |
| 330 | HAM |
| 400-450 | Structure of the apparatus of FIG. 4 |
| 510-550 | Phases of the method in FIG. 5 |

1. An apparatus comprising at least one processing core, at least one memory including computer program code, the at least one memory and the computer program code being configured to, with the at least one processing core, cause the apparatus at least to:
receive an accelerator programming request from an Acceleration Abstraction Layer, AAL,-Deployment Management Service, DMS, network component;
transmit a code retrieval request to a repository network component and receive a code fragment in response;
transmit a programming request with said code fragment to a hardware accelerator manager, to request the hardware accelerator manager to program at least one hardware accelerator node;
receive an indication indicating that the programming was successful in response to transmitting the programming request; and
transmit an indication indicating that accelerator programming was successful to the AAL-DMS.

2. An apparatus according to claim 1, wherein the at least one memory and the computer program code are further configured to, with the at least one processing core, cause the apparatus at least to:
operate as an Accelerator Programming, AP,-DMS network component.

3. An apparatus comprising at least one processing core, at least one memory including computer program code, the at least one memory and the computer program code being configured to, with the at least one processing core, cause the apparatus at least to:
transmit an accelerator programming request to an Accelerator Programming, AP,-Deployment Management Service, DMS, network component;
receive an indication indicating that accelerator programming was successful from the AP-DMS; and
transmit a program completion message to a deploy DMS.

4. An apparatus according to claim 3, wherein the at least one memory and the computer program code are further configured to, with the at least one processing core, cause the apparatus at least to:
operate as an Acceleration Abstraction Layer, AAL,-DMS network component.

5. An apparatus according to claim 3, wherein the at least one memory and the computer program code are further configured to, with the at least one processing core, cause the apparatus at least to:
receive, from a deploy DMS, a request to program an accelerator; and
transmit the accelerator programming request responsive to receiving the request.

6. An apparatus according to claim 3, wherein the accelerator programming request is a request to program at least one hardware accelerator node.

7. An apparatus according to claim 3, wherein the accelerator programming request is a request to program at least one hardware accelerator node for another network component.

8. An apparatus according to claim 7, wherein said another network component is an application or a cloudified network function.

9. A system, comprising:
an Acceleration Abstraction Layer, AAL,-Deployment Management Service, DMS, network component and an Accelerator Programming, AP-DMS network component,
wherein the AP-DMS network component is configured to:
receive an accelerator programming request from the AAL-DMS network component;
transmit a code retrieval request to a repository network component and receive a code fragment in response;
transmit a programming request with said code fragment to a hardware accelerator manager, to request the hardware accelerator manager to program at least one hardware accelerator node;
receive an indication indicating that the programming was successful in response to transmitting the programming request; and
transmit an indication indicating that accelerator programming was successful to the AAL-DMS; and
the AAL-DMS network component is configured to:
transmit an accelerator programming request to an AP-DMS network component;
receive an indication indicating that accelerator programming was successful from the AP-DMS; and
transmit a program completion message to a deploy DMS.

10. A system according to claim 9, wherein the AAL-DMS network component is further configured to:
receive, from a deploy DMS, a request to program an accelerator; and
transmit the an accelerator programming request responsive to receiving the request.

11. A system according to claim 9, wherein the accelerator programming request is a request to program at least one hardware accelerator node.

12. A system according to claim 9, wherein the accelerator programming request is a request to program at least one hardware accelerator node for another network component.

13. A system according to claim 12, wherein said another network component is an application or a cloudified network function.

14. A method, comprising:
receiving an accelerator programming request from an Acceleration Abstraction Layer, AAL,-Deployment Management Service, DMS, network component;
transmitting a code retrieval request to a repository network component and receiving a code fragment in response;
transmitting a programming request with said code fragment to a hardware accelerator manager, to request the hardware accelerator manager to program at least one hardware accelerator node;
receiving an indication indicating that the programming was successful in response to transmitting the programming request; and
transmitting an indication indicating that accelerator programming was successful to the AAL-DMS.

15. A method according to claim 14, further comprising:
operating as an Accelerator Programming, AP,-DMS network component.

16. A method, comprising:
transmitting an accelerator programming request to an Accelerator Programming, AP,-Deployment Management Service, DMS, network component;
receiving an indication indicating that accelerator programming was successful from the AP-DMS; and
transmitting a program completion message to a deploy DMS.

17. A method according to claim 16, further comprising:
operating as an Acceleration Abstraction Layer, AAL,-DMS network component.

18. A method according to claim 16, further comprising:
receiving, from a deploy DMS, a request to program an accelerator; and
transmitting the an accelerator programming request responsive to receiving the request.

19. A method according to claim 16, wherein the accelerator programming request is a request to program at least one hardware accelerator node.

20. A method according to claim 16, wherein the accelerator programming request is a request to program at least one hardware accelerator node for another network component, wherein said another network component is an application or a cloudified network function.

21-27. (canceled)
